(19) United States
(12) Patent Application Publication
(10) Pub. No.: US 2025/0363774 A1
(43) Pub. Date: Nov. 27, 2025

(54) TARGET TRACKING METHOD AND APPARATUS

(71) Applicants: Beijing BOE Technology Development Co., Ltd., Beijing (CN); BOE Technology Group Co., Ltd., Beijing (CN)

(72) Inventor: Fei LI, Beijing (CN)

(21) Appl. No.: 18/992,956

(22) PCT Filed: May 16, 2023
(86) PCT No.: PCT/CN2023/094508

§ 371 Date: Jan. 9, 2025

(51) Int. Cl. G06V 10/74; G06T 7/246; G06V 10/46; G06V 10/75; G06V 10/762

(52) U.S. Cl. CPC G06V 10/761; G06T 7/248; G06V 10/46; G06V 10/751; G06V 10/762

(57) ABSTRACT

The present disclosure provides a target tracking method and apparatus, relating to the field of image processing. According to embodiments of the present disclosure, a first image and a second image including a partially overlapping region synchronously collected by a first image-collecting device and a second image-collecting device are acquired, and first tracking detection blocks and second tracking detection blocks, for target tracking, of the first image and the second image are acquired respectively; the second tracking detection blocks are mapped to the first image according to a mapping relation between the first image-collecting device and the second image-collecting device, to obtain corresponding mapping blocks; and target objects in the overlapping region are fused according to intersection over union (IOU) and an appearance feature similarity level between the first tracking detection blocks and the mapping blocks.

### TECHNICAL FIELD

The present disclosure relates to the field of image processing, and in particular, to a target tracking method and apparatus.

### BACKGROUND

Multi-target tracking is to assign tracking identifiers to target objects in each frame of a video, so as to obtain a behavior track of each target object according to the tracking identifier. At present, an appearance feature of a tracked target object can be extracted by using a pedestrian re-identification (ReID) algorithm, and then matching of the tracked target object in multiple image-collecting devices is completed through a manner of feature matching association. However, for two image-collecting devices with an overlapping region, since collecting views of the two image-collecting devices are different, a same target object may have different appearance features in images collected by different image-collecting devices, for example, front of a pedestrian 1 is presented in a collecting view of an image-collecting device A, while back of the pedestrian 1 is presented in a collecting view of an image-collecting device B, which will result in a matching failure when the feature matching association is performed, causing the same target object to be assigned with different tracking identifiers, resulting in inaccurate tracking results.

### SUMMARY

The present disclosure provides a target tracking method and apparatus, to solve deficiencies in related arts.

According to a first aspect of embodiments of the present disclosure, a target tracking method is provided, including:
acquiring a first image and a second image synchronously collected by a first image-collecting device and a second image-collecting device, where the first image and the second image include an overlapping region;
acquiring first tracking detection blocks and second tracking detection blocks, for target tracking, of the first image and the second image respectively;
mapping the second tracking detection blocks to the first image according to a mapping relation between the first image-collecting device and the second image-collecting device, to obtain corresponding mapping blocks; and
fusing target objects in the overlapping region according to intersection over union (IOU) and an appearance feature similarity level between the first tracking detection blocks and the mapping blocks.

In some embodiments, fusing the target objects in the overlapping region according to the intersection over union (IOU) and the appearance feature similarity level between the first tracking detection blocks and the mapping blocks includes:
determining a matched weight between each first tracking detection block and each mapping block according to intersection over union between each first tracking detection block and each mapping block and an appearance feature similarity level between each first tracking detection block and each mapping block;
matching the first tracking detection blocks with the mapping blocks by using a weighted bipartite graph matching algorithm; and
when the first tracking detection block is matched with the mapping block, determining that a target object in the mapping block and a target object in the first tracking detection block are a same target object.

In some embodiments, the method further includes:
acquiring a first tracking identifier assigned to each first tracking detection block when target tracking is performed to the first image, where the first tracking identifier is globally unique;
acquiring a second tracking identifier assigned to each second tracking detection block when target tracking is performed to the second image, where the second tracking identifier is globally unique;
when determining that the target object in the mapping block and the target object in the first tracking detection block are the same target object, replacing the second tracking identifier of a second tracking detection block corresponding to the mapping block with the first tracking identifier of the first tracking detection block.

In some embodiments, after replacing the second tracking identifier of the second tracking detection block corresponding to the mapping block with the first tracking identifier of the first tracking detection block, the method further includes:
for other image pairs excluding a synchronized first frame image pair, acquiring a fusing result of each of the other image pairs, where the each of the other image pairs includes the first image and the second image, and the fusing result indicates whether tracking identifiers of the same target object in the first image and the second image are consistent;
when the fusing result indicates that the tracking identifiers of the same target object are not consistent, and one of the tracking identifiers is presented for a first time, replacing the tracking identifier presented for the first time with the tracking identifier already presented before; and
when the fusing result indicates that the tracking identifiers of the same target object are not consistent, and each of the tracking identifiers is not presented for a first time, acquiring a matching similarity level of the target object between a tracking detection block and a predicted block in a previous frame image pair respectively, and using a tracking identifier of the target object in an image with a higher matching similarity level to replace a tracking identifier of the target object in other image.

In some embodiments, acquiring first tracking detection blocks and second tracking detection blocks, for target tracking, of the first image and the second image respectively includes:
performing target detection to a first frame target image to obtain tracking detection blocks of target objects, creating a corresponding tracker and a corresponding feature library based on a tracking detection block of each target object, and assigning a tracking identifier to each target object, where the feature library is used to store an appearance feature of the target object, the target image includes the first image and the second image;
for other frame target images excluding the first frame target image, predicting a predicted block of each of the target objects based on respective tracker, matching based on intersection over union between each predicted block and each tracking detection block, and a similarity level between a first appearance feature of each target object in the feature library and a second appearance feature of each target object in the other frame target images;
for a tracking detection block matching with a corresponding predicted block, determining a tracking identifier of the predicted block as a tracking identifier of the tracking detection block in the other frame target images, and updating a tracker using a position of the tracking detection block, and updating the first appearance feature by using the second appearance feature; and
for a tracking detection block not matching with a corresponding predicted block, creating a corresponding tracker according to the tracking detection block, assigning a tracking identifier to the target object in the tracking detection block, and deleting the tracker that generates the predicted block.

In some embodiments, matching based on intersection over union between each predicted block and each tracking detection block, and the similarity level between the first appearance feature of each target object in the feature library and the second appearance feature of each target object in the other frame target images includes:
predicting a predicted block of each of the target objects by using different target tracking algorithms;
acquiring intersection over union between the predicted blocks predicted by using different target tracking algorithms and the tracking detection block respectively;
matching each predicted block and each tracking detection block based on different intersection over union and the similarity level between the first appearance feature in the feature library and the second appearance feature of the tracking detection block.

In some embodiments, the method further includes:
when target detection is performed to the target image, and when a specified target tracking algorithm in the different target tracking algorithms predicts that there is a predicted block of the target object, and no tracking detection block of the target object is detected, determining the predicted block of the target object predicted by the specified target tracking algorithm as the tracking detection block of the target object;
acquiring intersection over union between the predicted blocks predicted by using different target tracking algorithms and each tracking detection block in the target image respectively;
matching predicted blocks with tracking detection blocks based on different intersection over union and the similarity level between the first appearance feature in the feature library and the second appearance feature of each tracking detection block.

In some embodiments, the method further includes:
acquiring a first calibration image and a second calibration image synchronously collected by the first image-collecting device and the second image-collecting device;
detecting a first feature point of scale-invariant feature transform in the first calibration image and a second feature point of scale-invariant feature transform in the second calibration image;
matching the first feature point in the first calibration image with the second feature point in the second calibration image to obtain a feature point pair; and
determining the mapping relation between the first image-collecting device and the second image-collecting device according to homogeneous coordinates of the first feature point in the feature point pair and homogeneous coordinates of the second feature point in the feature point pair.

In some embodiments, after matching the first feature point in the first calibration image with the second feature point in the second calibration image to obtain the feature point pair, the method further includes:
acquiring target first feature points included in feature point pairs in a specified region of the first calibration image;
acquiring target second feature points, in the second calibration image, matched with all of the target first feature points in the specified region;
clustering all of the target second feature points in set regions, where a minimum distance between different set regions is greater than a size of the set regions, and the size of the set regions is equal to a size of the specified region;
acquiring a target set region with a maximum number of the target second feature points; and
updating feature point pairs including all of the target second feature points in the target set region as feature point pairs in the first calibration image and the second calibration image.

In some embodiments, acquiring the first image and the second image synchronously collected by the first image-collecting device and the second image-collecting device includes:
acquiring a first data stream collected by the first image-collecting device by using a first pull stream thread, storing the first data stream in a first queue, acquiring a second data stream collected by the second image-collecting device by using a second pull stream thread, and storing the second data stream in a second queue;
decoding the first data stream in the first queue by using a first decoding thread to obtain the first image, storing the first image in a third queue, decoding the second data stream in the second queue by using a second decoding thread to obtain the second image, and storing the second image in the third queue;
when the second image or the first image collected synchronously is not received beyond a set duration starting from receiving the first image or the second image, performing target tracking on the received first image or the received second image, and emptying the third queue; and
when the second image or the first image collected synchronously is received beyond the set duration starting from receiving the first image or the second image, determining the first image and the second image as images synchronously collected by the first image-collecting device and the second image-collecting device, and emptying the third queue.

According to a second aspect of embodiments of the present disclosure, a target tracking apparatus is provided, including:
an acquiring unit, configured to acquire a first image and a second image synchronously collected by a first image-collecting device and a second image-collecting device, where the first image and the second image include an overlapping region; and acquire first tracking detection blocks and second tracking detection blocks, for target tracking, of the first image and the second image respectively;
a mapping unit, configured to map the second tracking detection blocks to the first image according to a mapping relation between the first image-collecting device and the second image-collecting device, to obtain corresponding mapping blocks; and
a fusing unit, configured to fuse target objects in the overlapping region according to intersection over union (IOU) and an appearance feature similarity level between the first tracking detection blocks and the mapping blocks.

According to the above embodiments, a first image and a second image including a partially overlapping region synchronously collected by a first image-collecting device and a second image-collecting device are acquired, and first tracking detection blocks and second tracking detection blocks, for target tracking, of the first image and the second image are acquired respectively; the second tracking detection blocks are mapped to the first image according to a mapping relation between the first image-collecting device and the second image-collecting device, to obtain corresponding mapping blocks; and target objects in the overlapping region are fused according to intersection over union (IOU) and an appearance feature similarity level between the first tracking detection blocks and the mapping blocks. According to the mapping relation between the two image-collecting devices, second tracking detection blocks are mapped to the first image to obtain corresponding mapping blocks, and a first target object in the overlapping region in the first image and the second image is fused according to the intersection over union and the appearance feature similarity level between the first tracking detection blocks and the mapping blocks, thereby improving accuracy of target tracking.

It should be understood that the above general description and the following detailed description are exemplary and illustrative only and are not intended to limit the present disclosure.

### BRIEF DESCRIPTION OF DRAWINGS

Drawings herein are incorporated in and constitute a part of the specification, illustrating embodiments consistent with the present disclosure, and together with the description serve to explain principles of the present disclosure.

FIG. 1A is a schematic diagram of a multi-target tracking result in a first frame image according to an embodiment of the present disclosure.

FIG. 1B is a schematic diagram of a multi-target tracking result in a tenth frame image according to an embodiment of the present disclosure.

FIG. 2 is a schematic flowchart of a target tracking method according to an embodiment of the present disclosure.

FIG. 3A is a schematic flowchart of a method for implementing multi-target tracking in an overlapping region according to an embodiment of the present disclosure.

FIG. 3B is a schematic flowchart of a synchronous data collection method according to an embodiment of the present disclosure.

FIG. 4 is a schematic flowchart of multi-target tracking according to an embodiment of the present disclosure.

FIG. 5A is a schematic diagram of images collected by two image-collecting devices according to an embodiment of the present disclosure.

FIG. 5B is a schematic diagram of performing feature point detection on an image according to an embodiment of the present disclosure.

FIG. 5C is a schematic diagram of performing feature point matching on an image according to an embodiment of the present disclosure.

FIG. 6 is a schematic diagram of removing matching error feature points by using spatial verification according to an embodiment of the present disclosure.

FIG. 7 is a schematic diagram illustrating coordinate conversion according to a mapping relation according to an embodiment of the present disclosure.

FIG. 8 is a schematic diagram of a weighted bipartite graph matching algorithm according to an embodiment of the present disclosure.

FIG. 9A is a schematic diagram of a target tracking result in a first image-collecting device and a second image-collecting device according to an embodiment of the present disclosure.

FIG. 9B is a schematic diagram of mapping a target tracking result according to an embodiment of the present disclosure.

FIG. 9C is a schematic diagram of a fused target tracking result according to an embodiment of the present disclosure.

FIG. 10 is a schematic diagram of verifying a fusion result according to an embodiment of the present disclosure.

FIG. 11 is a schematic diagram of a tracking time sequence according to an embodiment of the present disclosure.

FIG. 12 is a schematic diagram of a target tracking apparatus according to an embodiment of the present disclosure.

### DETAILED DESCRIPTION

Exemplary embodiments will be described in detail herein, examples of which are illustrated in the accompanying drawings. The following description relates to the accompanying drawings, in which same numerals indicate same or similar elements unless otherwise indicated. The embodiments described in the following exemplary embodiments do not represent all embodiments consistent with the present disclosure. Rather, they are merely examples of apparatuses and methods consistent with some aspects of the present disclosure as detailed in the appended claims.

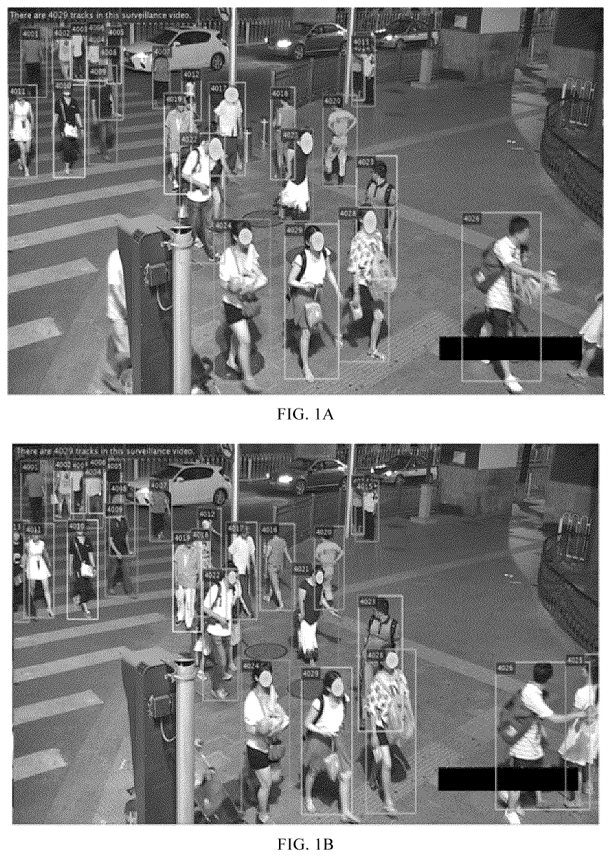

FIG. 1A is a schematic diagram of a multi-target tracking result in a first frame image according to an embodiment of the present disclosure, FIG. 1B is a schematic diagram of a multi-target tracking result in a tenth frame image according to an embodiment of the present disclosure. As shown in FIGS. 1A and 1B, the multi-target tracking is that a tracking identifier, also referred to as a tracking ID (identity document), is assigned to each target object on each frame of image in a video, for example, 4024, 4022, 4029, etc., and a behavior track corresponding to each tracking identifier may be obtained according to the tracking identifier of the target object.

A multi-target tracking algorithm can be applied to various aspects of a visual field, such as a security field, an automatic driving field and a medical field. In the security field, a number of people in a specific area can be counted through tracking; in the automatic driving field, a track of a pedestrian or a vehicle can be estimated through tracking; in the medical field, a movement condition of a cell can be obtained through tracking. The target object mentioned in the present disclosure may be determined according to an application scenario, for example, the target object may be a vehicle, a pedestrian, a cell, or the like.

In some scenarios, if a collecting view of an image-collecting device cannot cover a region of interest, two or more image-collecting devices may be laid out to acquire an image of the region of interest. When two or more image-collecting devices are used to acquire an image of the region of interest, the acquired images usually include an overlapping region. An appearance feature of the tracked target object can be extracted respectively, and then matching association of the target object in the multiple image-collecting devices is realized according to the appearance feature.

However, matching of the target object by using the appearance feature does not have a high accuracy, and specific reasons include: for two image-collecting devices with the overlapping region, since the collecting views of the two image-collecting devices are different, there will be different appearance features of a same target object in the images acquired by different image-collecting devices, for example, front of a user 1 is presented in a collecting view of an image-collecting device A, while sides of the user 1 is presented in the collecting view of an image-collecting device B, and it is easy to cause a matching failure when the appearance features of the front and the appearance features of the sides are used for feature matching.

In view of this, the present disclosure provides a target tracking method, and the method fuses a target object in an overlapping region based on a coordinate mapping relation between image-collecting devices to complete multi-target tracking.

The following embodiments describe a target tracking method provided in the present disclosure with reference to the accompanying drawings.

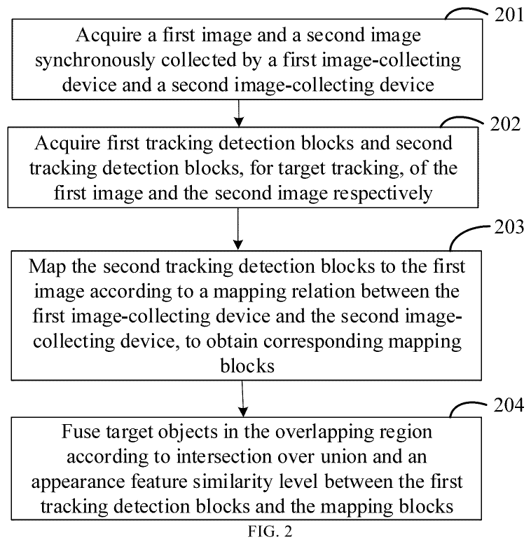

FIG. 2 is a schematic flowchart of a target tracking method according to an embodiment of the present disclosure. As shown in FIG. 2, the target tracking method includes following steps 201-204.

In step 201, a first image and a second image synchronously collected by a first image-collecting device and a second image-collecting device are acquired.

The first image and the second image include an overlapping region.

In this embodiment, a collecting view of the first image-collecting device partially overlaps a collecting view of the second image-collecting device, that is, the first image collected by the first image-collecting device and the second image collected by the second image-collecting device have an overlapping region.

In an implementation, the first image acquired by the first image-collecting device and the second image acquired by the second image-collecting device may be acquired respectively, and the second image acquired synchronously with the first image may be acquired according to collecting times of the first image and the second image.

In step 202, first tracking detection blocks and second tracking detection blocks, for target tracking, of the first image and the second image are acquired respectively.

When the first image and the second image that are synchronously collected are acquired, target tracking may be performed on the first image to obtain a plurality of first tracking detection blocks in the first image, and target tracking may be performed on the second image to obtain a plurality of second tracking detection blocks in the second image.

In this embodiment, target tracking may be performed on the first image and the second image respectively by using a multi-target tracking algorithm based on detection (tracking-by-detection). For example, a SORT (Simple Online and Real time Tracking) algorithm may be used to respectively perform target tracking on the first image and the second image to obtain a plurality of first tracking detection blocks and a plurality of second tracking detection blocks.

In step 203, the second tracking detection blocks are mapped to the first image according to a mapping relation between the first image-collecting device and the second image-collecting device, to obtain corresponding mapping blocks.

In this embodiment, the mapping relation between the first image-collecting device and the second image-collecting device may be obtained in advance, and when first tracking detection blocks of the first image and second tracking detection blocks of the second image are obtained, the second tracking detection blocks may be mapped to an image coordinate system in which the first image is located according to the mapping relation to obtain corresponding mapping blocks.

In step 204, target objects in the overlapping region are fused according to intersection over union (IOU) and an appearance feature similarity level between the first tracking detection blocks and the mapping blocks.

In this embodiment, the first tracking detection blocks may be matched with the mapping blocks based on an intersection over union (IOU) and an appearance feature similarity level, and if a first tracking detection block is successfully matched with a mapping block, it indicates that a target object in the first tracking detection block and a target object in a second tracking detection block corresponding to the mapping block are a same target object located in the overlapping region.

In this embodiment, when it is determined that the target object in the first image acquired by the first image-collecting device and the target object in the second image acquired by the second image-collecting device are the same target object, face image information of the target object may be obtained, and the face image information may be stored in association with a first tracking identifier of the target object in the first image-collecting device and a second tracking identifier of the target object in the second image-collecting device. In practical applications, the face image information, the first tracking identifier and the second tracking identifier having the association relation may be displayed at the same time to prompt a user that the first tracking identifier and the second tracking identifier correspond to the same target object.

Those skilled in the art should understand that, in addition to the foregoing display manner, a same identifier (for example, same color) may also be used to indicate that the first tracking identifier and the second tracking identifier represent a same target object, which is not limited in the present disclosure.

As described above, a first image and a second image including a partially overlapping region synchronously collected by a first image-collecting device and a second image-collecting device are acquired, and first tracking detection blocks and second tracking detection blocks, for target tracking, of the first image and the second image are acquired respectively; the second tracking detection blocks are mapped to the first image according to a mapping relation between the first image-collecting device and the second image-collecting device, to obtain corresponding mapping blocks; and target objects in the overlapping region are fused according to intersection over union (IOU) and an appearance feature similarity level between the first tracking detection blocks and the mapping blocks. According to the mapping relation between the two image-collecting devices, second tracking detection blocks are mapped to the first image to obtain corresponding mapping blocks, and a first target object in the overlapping region in the first image and the second image is fused according to the intersection over union and the appearance feature similarity level between the first tracking detection blocks and the mapping blocks, thereby improving accuracy of target tracking.

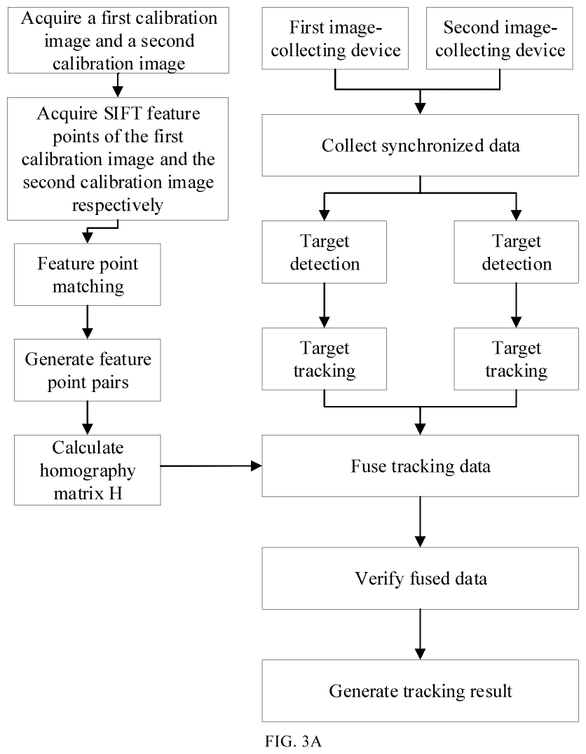

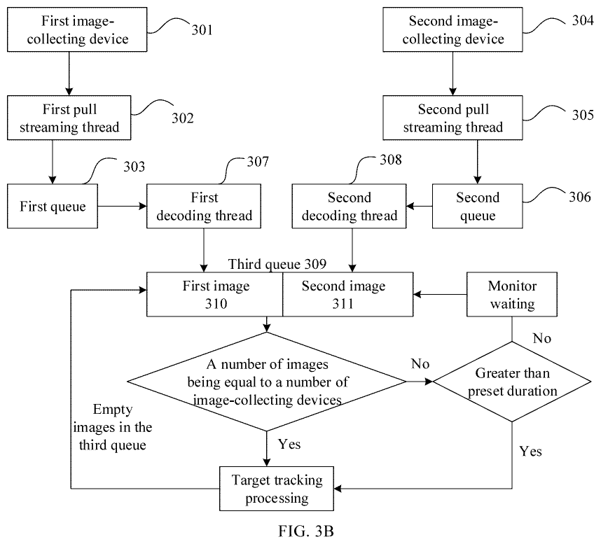

Before each step is described, this embodiment describes an overall concept of the present disclosure with reference to FIG. 3A.

FIG. 3A is a schematic flowchart of a method for implementing multi-target tracking in an overlapping region according to an embodiment of the present disclosure. As shown in FIG. 3A, the method for implementing multi-target tracking in the overlapping region includes two parts:

I. A mapping relation between the first image-collecting device and the second image-collecting device having partially overlapping collecting views is obtained, and the mapping relation in this embodiment refers to a homography matrix.

A first calibration image and a second calibration image synchronously collected by the first image-collecting device and the second image-collecting device are acquired; a first feature point of scale-invariant feature transform (SIFT) in the first calibration image and a second feature point of scale-invariant feature transform in the second calibration image are detected; the first feature point in the first calibration image is matched with the second feature point in the second calibration image to obtain a feature point pair; and a mapping relation between the first image-collecting device and the second image-collecting device is determined according to homogeneous coordinates of the first feature point in the feature point pair and homogeneous coordinates of the second feature point in the feature point pair.

II. Multi-object tracking, i.e., object detection and matching.

### 1. Synchronous Collection of Data;

A same target object presents a maximum similarity level in different image-collecting devices at a same moment. In order to fuse the same target object in the overlapping region of the two image-collecting devices, the first image and the second image collected synchronously by the first image-collecting device and the second image-collecting device are acquired in this embodiment. When a difference between the collection time of the first image and the collecting time of the second image is less than a set duration, it is considered that the first image and the second image are images synchronously collected.

### 2. Performing Target Detection and Tracking on the Collected Synchronized Data Respectively;

Performing target detection and positioning on the synchronously collected images by using a target detection algorithm, where the target detection algorithm may include an algorithm such as yolov5 or FaserRenn. Creating a tracker for each detection result by using a Kalman filtering model, and generating a tracking identifier of each detection result in a corresponding image-collecting device.

### 3. Tracking Data Fusion;

The tracking result in the second image-collecting device is mapped to the image coordinate system where the first image-collecting device is located through the mapping relation, matching association is performed according to the intersection over union and the appearance feature between the tracking result and the mapping result in the first image-collecting device, the tracking identifiers of the target objects on the association are unified, and the tracking identifier of the same target object is globally unique in the region where the first image-collecting device and the second image-collecting device cooperatively collect.

### 4. Verifying Fused Data.

In a first frame, since the tracking identifier of the target object is initially created, the same target object generally has different tracking identifiers, and after one fusion is performed by using the foregoing steps, the same target object will have the same tracking identifier. Verifying whether the fusion result in the subsequent frame is correct based on the same tracking identifier of the same target object in different image-collecting devices after fusion.

Each step will be described in detail in the following embodiments.

In some embodiments, images synchronously collected by any two image-collecting devices having an overlapping region may be acquired in a multi-thread manner. That is, acquiring the first image and the second image synchronously collected by the first image-collecting device and the second image-collecting device may include the following steps 2011 to 2013.

In step 2011, acquiring a first data stream collected by the first image-collecting device by using a first pull stream thread, storing the first data stream in a first queue, acquiring a second data stream collected by the second image-collecting device by using a second pull stream thread, and storing the second data stream in a second queue.

FIG. 3B is a schematic flowchart of a synchronous data collecting method according to an embodiment of the present disclosure, as shown in FIG. 3B, a first pull stream thread 302 (i.e., pull camera-stream thread) acquires a first data stream acquired by a first image-collecting device 301 and stores the first data stream into a first queue 303, and a second pull stream thread 305 acquires a second data stream acquired by a second image-collecting device 304 and stores the second data stream into a second queue 306.

In step 2012, decoding the first data stream in the first queue by using a first decoding thread to obtain the first image, storing the first image in a third queue, decoding the second data stream in the second queue by using a second decoding thread to obtain the second image, and storing the second image in the third queue.

As shown in FIG. 3B, a first decoding thread 307 is used to decode the first data stream in the first queue 303 to obtain the first image 308, the first image 308 is stored in a third queue 309, a second decoding line 310 is used to decode the second data stream in the second queue 306 to obtain the second image 311, and the second image 311 is stored in the third queue 309. In an example, the first image and the second image may be stored in association with the collecting time of the first image and the second image, and the ID of the corresponding image-collecting device, so as to query information corresponding to the image.

In step 2013a, when the second image or the first image collected synchronously is not received beyond a set duration starting from receiving the first image or the second image, performing target tracking on the received first image or the received second image, and emptying the third queue.

As shown in FIG. 3B, in response to detecting that the first image or the second image is received in the third queue, in this case, a number of images in the third queue being 1 does not match a number of image-collecting devices, it is determined whether a set duration is reached since the first image or the second image is received, and if the set duration is reached, it is detected whether the synchronously collected second image or first image is received. If the second image or the first image collected synchronously is not received within the set duration, performing target tracking processing on the received first image or second image, and emptying the third queue. A process of target tracking processing is specifically described in subsequent embodiments.

When a waiting duration is greater than the set duration, target tracking is performed on the received first image or second image, and when a network of one of the image-collecting devices is unstable or abnormal, another one of the image-collecting devices is not affected, thereby ensuring data flow stability.

In step 2013b, when the second image or the first image collected synchronously is received beyond the set duration starting from receiving the first image or the second image, determining the first image and the second image as images synchronously collected by the first image-collecting device and the second image-collecting device, and emptying the third queue.

If the second image or the first image is received beyond the set duration, it is considered that the received first image and the received second image are synchronously acquired, and therefore, target tracking processing is performed on the synchronously acquired first image and second image respectively, and the third queue is emptied.

After the first image or the second image is received from the third queue, all received images are output and the third queue is emptied after the set duration is exceeded, so as to receive the first image and the second image that are synchronously collected in a next frame.

When the first image and the second image that are synchronously collected are acquired by using the foregoing method, a time difference between collecting the first image and collecting the second image is less than a set duration, and the set duration may be determined based on a frame rate of the image-collecting device, for example, the set duration is equal to 1000/fps, where fps represents a frame rate of the image-collecting device. For example, when the frame rate of the first image-collecting device is 25, a time difference between collecting the first image and collecting the second image should be less than 40 ms.

When the first image and the second image synchronously acquired by the first image-collecting device and the second image-collecting device are acquired, target tracking may be performed on the first image to obtain a plurality of first tracking detection blocks, and target tracking may be performed on the second image to obtain a plurality of second tracking detection blocks. Considering that the processing processes of performing target tracking on the first image and the second image are the same, for ease of description, in this embodiment, a target image is used to refer to the first image and the second image, and the following embodiment describes a process of performing target tracking on the target image.

Performing target detection and appearance feature extraction on a first frame of target image, creating a tracker and a feature library for each target object based on a tracking detection block obtained by the target detection, and assigning a tracking identifier to a tracking detection block corresponding to the target object, where the feature library is used to store an appearance feature of the target object.

Performing target detection on other frames of target images except the first frame of target image to obtain a plurality of tracking detection blocks, extracting a second appearance feature of each target object, predicting a predicted block of each target object in the other frames of target images by using created trackers, and matching according to an intersection over union between each predicted block and each tracking detection block and a similarity level between a first appearance feature of each target object in the feature library and the second appearance feature of each target object.

For a tracking detection block matching with a corresponding predicted block, determining a tracking identifier of the predicted block as a tracking identifier of the tracking detection block in the other frame target images, and updating a tracker using a position of the tracking detection block, and updating the first appearance feature by using the second appearance feature.

For a tracking detection block not matching with a corresponding predicted block, creating a corresponding tracker according to the tracking detection block, assigning a tracking identifier to the target object in the tracking detection block, and deleting the tracker that generates the predicted block.

In this embodiment, an age of each tracker is set to 1, that is, the tracker is deleted once failing to match, thereby reducing errors caused by misprediction.

The appearance feature in this embodiment may be a feature of a histogram of oriented gradients (HOG), a fused histogram of oriented gradients (FHOG), a color histogram, or a deep Convolutional Neural Network (CNN), the appearance feature of the target object in the first frame of the target image and the appearance feature of the target object in the subsequent frames when the predicted block and the tracking detection block in the subsequent frames are matched may be stored in the feature library corresponding to the target object, and the first appearance feature may be determined according to a plurality of appearance features in the feature library, for example, may be an average feature of the plurality of appearance features in the feature library, or a mean square error of the plurality of appearance features, etc. The manner of determining the first appearance feature in this embodiment may smooth fluctuation of the appearance feature, for example, fluctuation of the appearance feature caused by a bending or squatting posture of the target object, and fluctuation of the appearance feature caused by a color change of the target object due to light influence.

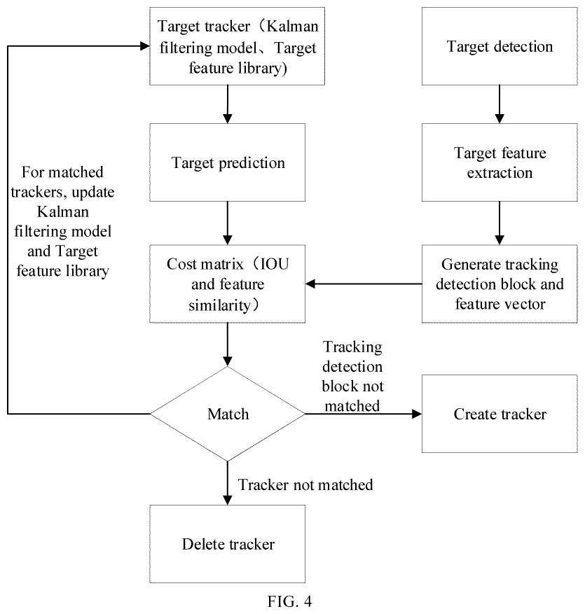

FIG. 4 is a schematic flowchart of multi-target tracking according to an embodiment of the present disclosure, as shown in FIG. 4, a tracker constructed based on a Kalman filtering model may be used for prediction, a prediction result is associated with a detection result, and an appearance feature is associated with an average feature in the tracker, and a cost matrix is calculated according to the following formula (1).

$$C = [ \begin{matrix}{IOU}_{11} & {IOU}_{ij} & {IOU}_{1 n} \\ {IOU}_{j i} & {IOU}_{i j} & {IOU}_{i j} \\ {IOU}_{m 1} & {IOU}_{i j} & {IOU}_{m n}\end{matrix} ] + w [ \begin{matrix}{F}_{11} & {F}_{i j} & {F}_{1 n} \\ {F}_{j i} & {F}_{i j} & {F}_{i j} \\ {F}_{m 1} & {F}_{i j} & {F}_{m n}\end{matrix} ] \qquad Formula ( 1 )$$

In formula (1), IOU represents an intersection over union between the tracking detection block and the predicted block, IOUₘₙ represents an intersection over union between the m-th tracking detection block and the n-th predicted block, m and n are positive integers, F represents similarity level between appearance features in the tracking detection block and the predicted block, Fₘₙ represents similarity level between an appearance feature in the m-th tracking detection block and an appearance feature in the n-th predicted block, and w represents a weight parameter. In this embodiment, the appearance feature in the predicted block may be determined based on the first appearance feature in the feature library.

In this embodiment, weighted fusion is performed based on motion information (that is, the tracking detection block) and the appearance feature information of the target object, to provide a basis for accurate matching of the target object in a single image-collecting device.

According to the above cost matrix, the association of the tracking detection block and the predicted block predicted by the tracker is realized by adopting a weighted bipartite graph matching algorithm, a tracker is created for the tracking detection block not matched, and the tracker which cannot be matched is deleted; for the matched tracker, the tracker is updated by adopting the matched tracking detection block, namely the Kalman filtering model is updated, the prediction accuracy of the tracker on the position of the predicted block in the next frame of image can be improved through updating, and the first appearance feature is updated by adopting a feature averaging manner. For example, the first appearance feature may be updated by using formula (2).

$${V}_{t} = \frac{{\sum }_{0}^{T} {v}_{i}}{T} \qquad Formula ( 2 )$$

In formula (2), Vt represents an average feature, that is, a first appearance feature, vi represents an i-th appearance feature that has been matched, T represents a number of appearance features that have been matched, and in an example, T may be set to 50.

In some embodiments, in order to solve a prediction limitation of the Kalman filtering model, for example, when the target object moves nonlinearly or a current frame of the target object is not effectively identified and positioned (in the case of missing identification), a single-target tracking algorithm may be used to perform compensation tracking, that is, a plurality of different target tracking algorithms are used to predict the predicted block of the target object; an intersection over union between the predicted block predicted by using the plurality of different target tracking algorithms and the tracking detection block is obtained; and matching between each predicted block and each tracking detection block is performed based on different intersection over union and the similarity level between the first appearance feature in the feature library and the second appearance feature of the tracking detection block.

In this embodiment, in addition to using the Kalman filtering model to perform prediction, a median optical flow tracking algorithm and a single-target tracking algorithm based on correlation filtering may also be simultaneously used to perform prediction, that is, IOU association matrices of other two prediction manners are added based on formula (1). The single-target tracking algorithm based on correlation filtering may include KCF (Kernelized Correlation Filters), CSK (Exploiting the Circulant Structure of Tracking-by-detection with Kernels), DCF (Discriminative Correlation Filter), SRDCF (Spatially Regularized Discriminative Correlation Filter), and the like.

In an implementation, prediction is performed by using a Kalman filtering model, a median optical flow tracking algorithm, and a correlation filtering KCF algorithm, and in this case, the cost matrix may be calculated according to formula (3).

$$C = k [ \begin{matrix}{IOU}_{11} & {IOU}_{i j} & {IOU}_{1 n} \\ {IOU}_{j i} & {IOU}_{ij} & {IOU}_{i j} \\ {IOU}_{m 1} & {IOU}_{ij} & {IOU}_{m n}\end{matrix} ] + c [ \begin{matrix}{IOU}_{11} & {IOU}_{i j} & {IOU}_{1 n} \\ {IOU}_{j i} & {IOU}_{ij} & {IOU}_{ij} \\ {IOU}_{m 1} & {IOU}_{ij} & {IOU}_{mn}\end{matrix} ] + m [ \begin{matrix}{IOU}_{11} & {IOU}_{ij} & {IOU}_{1 n} \\ {IOU}_{j i} & {IOU}_{i j} & {IOU}_{i j} \\ {IOU}_{m 1} & {IOU}_{i j} & {IOU}_{m n}\end{matrix} ] + w [ \begin{matrix}{F}_{11} & {F}_{ij} & {F}_{1 n} \\ {F}_{j i} & {F}_{i j} & {F}_{i j} \\ {F}_{m 1} & {F}_{i j} & {F}_{m n}\end{matrix} ] \qquad Formula ( 3 )$$

In formula (3), k represents a weight of the prediction of the Kalman filtering model and the IOU cost matrix of the current frame detection, c represents a weight of the prediction of the correlation filtering FCK and the IOU cost matrix of the current frame detection, and m is a weight of the median optical flow tracking algorithm and the IOU cost matrix of the current frame detection.

In actual application, the weight parameter may be adjusted according to a specific tracking scenario, to ensure that the previous frame sufficiently associates and matches the predicted block of the current frame with the tracking detection block of the current frame.

Those skilled in the art should understand that, in addition to performing prediction by using the Kalman filtering model, the median optical flow tracking algorithm, and the correlation filtering KCF algorithm, prediction may also be performed by using a combination of other target tracking algorithms, which is not limited in this embodiment.

For the single-target tracking algorithm, essentially, a position of the target object in the current frame is predicted according to a position of the target object in the previous frame, so when the target object in the current frame is not detected due to sheltering or deformation, the prediction result obtained by using the median optical flow tracking algorithm or the KCF algorithm is more accurate due to more factors considered, so that the predicted block predicted by the median optical flow tracking algorithm or the predicted block predicted by the KCF algorithm can be determined as the tracking detection block of the target object, that is, the predicted block is used to replace the tracking detection block. The Kalman filtering model is updated by using the substituted tracking detection frame, so as to prevent the prediction of the position of the subsequent target object by the Kalman filtering model from being affected due to missed detection of the target object, thereby avoiding jump of the target tracking identifier caused by missed detection of the target detector.

In some embodiments, when target detection is performed to the target image, and when a specified target tracking algorithm in the different target tracking algorithms predicts that there is a predicted block of the target object, and no tracking detection block of the target object is detected, determining the predicted block of the target object predicted by the specified target tracking algorithm as the tracking detection block of the target object;
acquiring intersection over union between the predicted blocks predicted by using different target tracking algorithms and each tracking detection block in the target image respectively;
matching predicted blocks with tracking detection blocks based on different intersection over union and the similarity level between the first appearance feature in the feature library and the second appearance feature of each tracking detection block.

The following embodiments will be described with reference to the accompanying drawings to calculate a homography matrix of image-collecting devices having an overlapping region.

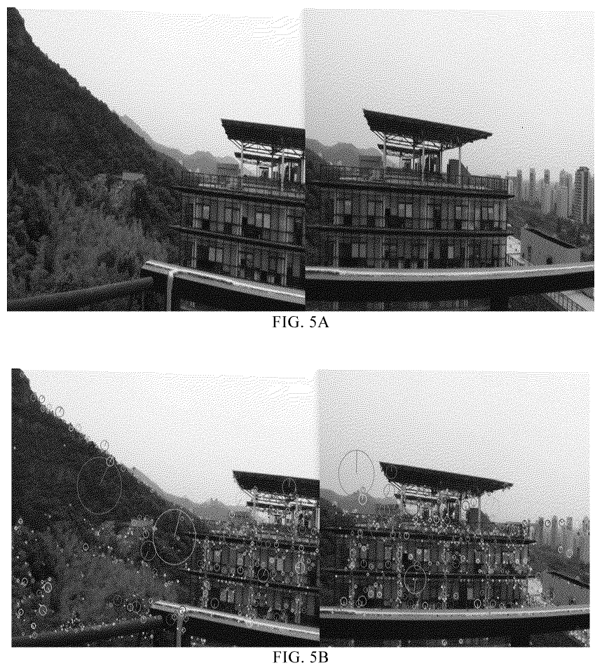

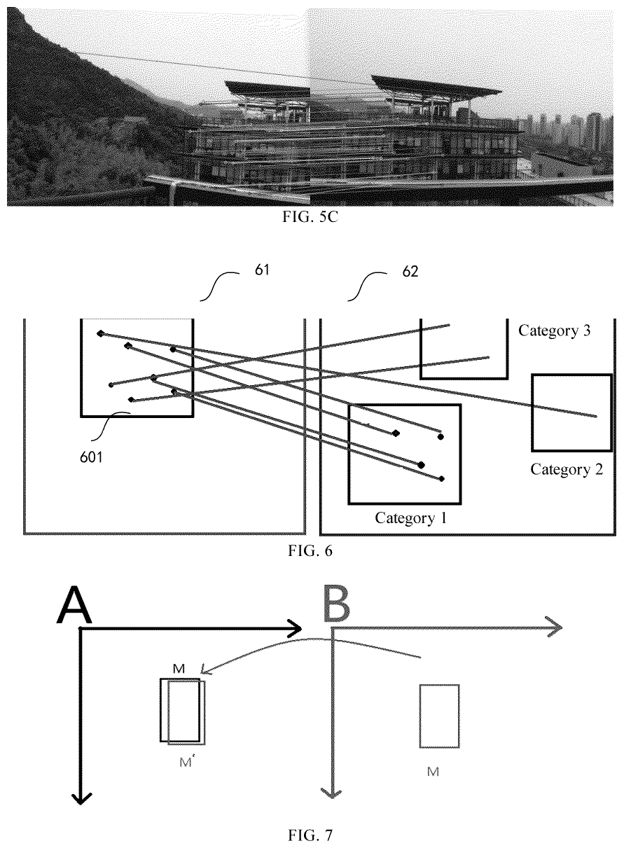

In this embodiment, a first calibration image and a second calibration image synchronously collected by the first image-collecting device and the second image-collecting device may be acquired through multiple threads, as shown in FIG. 5A, which is an image collected by the first image-collecting device and the second image-collecting device based on respective views.

SIFT (scale-invariant feature transform) feature points in the first calibration image and the second calibration image are respectively detected, as shown in FIG. 5B, SIFT feature point detection is performed on each calibration image.

In an implementation, a region of interest (ROI) in the first calibration image and a region of interest (ROI) in the second calibration image may be determined according to an overlapping region of two image-collecting devices, and then SIFT feature points in the ROI are obtained respectively.

When the first feature point in the first calibration image and the second feature point in the second calibration image are obtained, the feature points in the two calibration images may be matched. In this embodiment, a cross-matching algorithm and/or a nearest neighbor matching algorithm may be used for feature point matching.

The feature point matching is performed by using a cross-matching algorithm, including: acquiring, in the second calibration image, a second feature point that is closest to the first feature point P1 in the first calibration image and that is less than a threshold; vice versa, acquiring, in the first calibration image, a first feature point P1 that is closest to the second feature point P2 in the second calibration image and that is less than the threshold; and if two results obtained are the same, it is indicated that the first feature point P1 matches the second feature point P2.

For example, the image on the left side of FIG. 5C is the first calibration image, and the image on the right side of FIG. 5C is the second calibration image, where a distance between a first feature point P1 in the first calibration image is closest to a second feature point P2 in the second calibration image and is less than a threshold R, it indicates that the first feature point P1 and the second feature point P2 can be matched, and then it is verified whether the second feature point P2 in the second calibration image has a closest distance to the first feature point P1 in the first calibration image and is less than the threshold R, and if yes, the first feature point P1 and the second feature point P2 are determined as a feature point pair, that is, the first feature point P1 and the second feature point P2 are a pair of matching points.

The nearest neighbor matching algorithm is to perform feature point matching based on the principle that the similarity level between the first feature point P1 and the second feature point P2 is greater than the similarity level between the first feature point P1 and other feature points in the second calibration image.

Performing feature point matching by using the nearest neighbor matching algorithm includes: for a first feature point P1 in the first calibration image, acquiring two second feature points P2 and P3 closest to the first feature point P1 in the second calibration image, where a distance between the first feature point P1 and the second feature point P2 is D1, a distance between the first feature point P1 and the second feature point P3 is D2, and determining the first feature point P1 and the second feature point P2 as a feature point pair when D1/D2 is less than a threshold.

In this embodiment, when the nearest neighbor matching algorithm is used to perform feature point matching, a smaller threshold may be set to retain more matching points. However, a smaller threshold may retain some erroneous matching points, and therefore, when feature point matching is performed by using the nearest neighbor matching algorithm, the erroneous matching points may be removed by using a spatial verification method.

In this embodiment, to further ensure correctness of matching, space verification is added based on cross-matching and nearest neighbor matching, that is, after matching the first feature point in the first calibration image with the second feature point in the second calibration image to obtain the feature point pair, the method further includes: acquiring, in a specified region of the first calibration image, target first feature points included in the feature point pair in the specified region; acquiring, in the second calibration image, target second feature points matching with all of the target first feature points in the specified region; clustering all the target second feature points by using a set region, where a minimum distance between different set regions is greater than a size of the set regions, and the size of the set regions is equal to a size of the specified region; acquiring a target set region with a largest number of target second feature points; and updating feature point pairs including all of the target second feature points in the target set region as feature point pairs in the first calibration image and the second calibration image.

FIG. 6 is a schematic diagram of removing matching error feature points by using spatial verification according to an embodiment of the present disclosure. As shown in FIG. 6, a specified region 601 is selected in a first calibration image 61, a set size of the specified region 601 may be 20*20, and target second feature points matching with all target first feature points in the specified area are acquired in a second calibration image 62; hierarchical clustering is performed based on pixel distances according to position distribution of all target second feature points in the second calibration image, and a minimum value of a class spacing is greater than a size of the set region, for example, 20 pixels; and a region where a class with a largest proportion of clustering points is located is acquired as a target set region, feature point pairs in the target set region is reserved, and feature point pairs of points matching with other classes is deleted, that is, feature point pairs in a class 1 is reserved, and feature point pairs of class 2 and class 3 is deleted.

When the matched feature point pair is obtained, a homography matrix H may be calculated based on the matched feature point pair by using a RANSAC (Random Sample Consensus) algorithm, to obtain the mapping relation between the first image and the second image.

In this embodiment, coordinate transformation from the first image-collecting device to the second image-collecting device may be established, as shown in formula (4).

$$[ \begin{matrix}{x}_{1} \\ {y}_{1} \\ 1\end{matrix} ] = [ \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ] * [ \begin{matrix}{x}_{2} \\ {y}_{2} \\ 1\end{matrix} ] \qquad Formula ( 4 )$$

In formula (4), (x1, y1, 1) are homogeneous coordinates of a first feature point in the feature point pair, (x2, y2, 1) are image homogeneous coordinates of a second feature point in the feature point pair, and the homography matrix H is shown in formula (5).

$$H = [ \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ] \qquad Formula ( 5 )$$

In an implementation, the plurality of first tracking detection blocks may be mapped to the second image according to a mapping relation between the first image-collecting device and the second image-collecting device to obtain corresponding mapping blocks; and the target objects in the overlapping region are fused according to an intersection over union and appearance feature similarity level between the plurality of second tracking detection blocks and the plurality of mapping blocks. The plurality of first tracking detection blocks in the first image are mapped into the second image, and the plurality of second tracking detection blocks in the second image are mapped into the first image, so that the maximum number of fused target objects is obtained, and the fusion accuracy is improved.

For example, after the plurality of first tracking detection blocks in the first image are mapped to the second image for fusion, 4 target objects may be fused, and after the plurality of second tracking detection blocks in the second image are mapped to the first image for fusion, 5 target objects may be fused, so that the plurality of second tracking detection blocks in the second image are selected to be mapped to the first image for fusion, thereby avoiding inaccurate fusion results caused by sheltering between target objects in the first image.

In the foregoing embodiment, each image-collecting device performs independent target tracking, so that a target object has a unique tracking identifier in a single image-collecting device, and in order to ensure that a same target object in an overlapping region has a globally unique tracking identifier, tracking data in each image-collecting device may be fused according to a mapping relation. The tracking data fusion in this embodiment may be understood as merging tracking results in an overlapping region, so that a same target object has a unique tracking identifier in two image-collecting devices.

In some embodiments, fusing the target objects in the overlapping region according to the intersection over union (IOU) and the appearance feature similarity level between the first tracking detection blocks and the mapping blocks may include: determining a matching weight of each first tracking detection block and each mapping block according to the intersection over union between each first tracking detection block and each mapping block and the appearance feature similarity level between each first tracking detection block and each mapping block; matching the plurality of first tracking detection blocks with the plurality of mapping blocks by using a weighted bipartite graph matching algorithm; and when a first tracking detection block matches a mapping block, determining that the target object in the mapping block and the target object in the first tracking detection block are the same target object.

In some embodiments, fusing the target objects in the overlapping region includes:
acquiring a first tracking identifier assigned to each first tracking detection block when target tracking is performed to the first image, where the first tracking identifier is globally unique;
acquiring a second tracking identifier assigned to each second tracking detection block when target tracking is performed to the second image, where the second tracking identifier is globally unique;
when determining that the target object in the mapping block and the target object in the first tracking detection block are the same target object, replacing the second tracking identifier of a second tracking detection block corresponding to the mapping block with the first tracking identifier of the first tracking detection block.

FIG. 7 is a schematic diagram of performing coordinate conversion according to a mapping relation according to an embodiment of the present disclosure. As shown in FIG. 7, a second tracking detection block M in a second image-collecting device B is mapped to an image coordinate system where a first image-collecting device A is located through a homography matrix H to obtain a corresponding mapping block M′; and a fusion cost matrix of IOU and appearance feature is calculated according to the first tracking detection block M and the mapping block M′ in the first image-collecting device, and fusion matching is performed by using a weighted bipartite graph matching algorithm.

In an embodiment, the tracking detection block may be represented by two point pairs.

Calculating the IOU between all the tracking detection blocks in the first image coordinate system corresponding to the first image and the mapping block obtained after mapping all the second tracking detection blocks to the first image coordinate system, and a cosine distance between the appearance feature corresponding to the region where the tracking detection block is located in the first image and the appearance feature corresponding to the mapping block, calculating a cost matrix according to formula (1), then performing matching association according to the weighted bipartite graph matching algorithm, and modifying the fused tracking identifiers of the two target objects into the unified tracking identifier.

In an implementation, the appearance feature corresponding to the mapping block may be an average feature of a plurality of frames of matched target objects before the current frame.

In this embodiment, a weighted bipartite graph matching algorithm is used, and a largest advantage lies in that optimal matching between a tracking detection block and a mapping block can be implemented. Since it is known that the first image and the second image have an overlapping region, that is, there is high probability that the target object appearing in the overlapping region of the first image-collecting device may also appear in the overlapping region of the second image-collecting device. Therefore, acquiring of a maximum number of matched tracking detection blocks and mapping blocks is more practical.

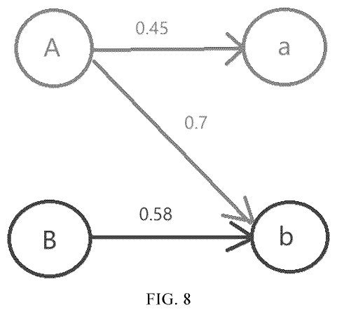

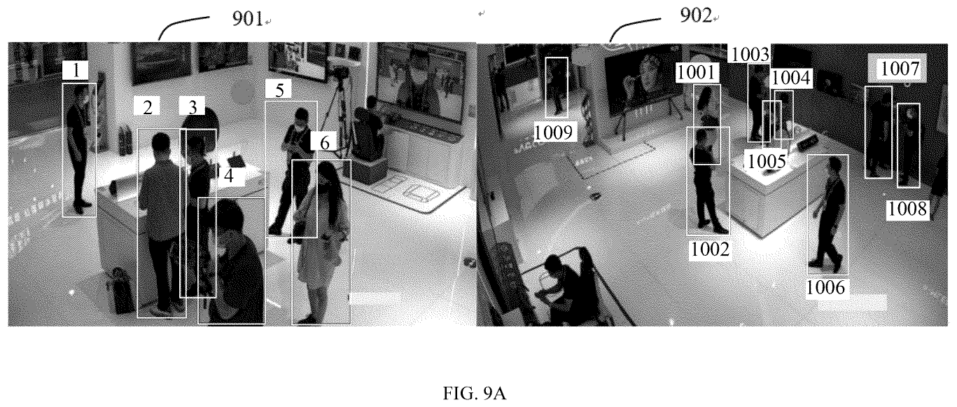

FIG. 8 is a schematic diagram of a weighted bipartite graph matching algorithm according to an embodiment of the present disclosure. As shown in FIG. 8, a target object in a first image-collecting device is represented by an uppercase letter, a target object in a second image-collecting device is represented by a lowercase letter, a weight of the target object A in the first image-collecting device and the target object a in the second image-collecting device is 0.45, a weight of a target object b is 0.7, and a similarity level between a target object B in the first image-collecting device and the target object b in the second image-collecting device is 0.58. When maximum similarity matching is used, since matching probability between the tracking detection block and the mapping block in the overlapping region is relatively high, a threshold used to define whether the tracking detection block and the mapping block are matched is not easy to be determined, and if 0.5 is selected as the threshold, it is obvious that A and b will be matched in the matching in FIG. 8, while B has no matching object.

In this embodiment, the weighted bipartite graph matching algorithm is used, and when B has no matching object, association errors caused by maximum similarity matching can be avoided by adjusting the threshold.

It can be learned from the above embodiments that the present embodiment provides a target tracking method, where the method may include:
acquiring a first image and a second image synchronously collected by the first image-collecting device and the second image-collecting device, where the first image and the second image include an overlapping region;
acquiring first tracking detection blocks and a first tracking identifier corresponding to each first tracking detection block obtained by performing target tracking to the first image, and acquiring second tracking detection blocks and a second tracking identifier corresponding to each second tracking detection block obtained by performing target tracking to the second image;
mapping the second tracking detection blocks to the first image according to a homography matrix between the first image-collecting device and the second image-collecting device, to obtain corresponding mapping blocks; and
matching the first tracking detection blocks with the mapping blocks by using a weighted bipartite graph matching algorithm, and replacing a second tracking identifier of a successfully matched second tracking detection block with a first tracking identifier of a first tracking detection block.

For each of the multiple tracking targets in the overlapping region of the two image-collecting devices, a weight is calculated based on the IOU and the similarity level of the tracking detection block, and tracking results of trackers of the two image-collecting devices are fused by adopting the weighted bipartite graph matching algorithm, so that the accuracy of tracking detection block fusion during multi-target tracking of the multi-image-collecting devices can be improved.

In the process of mapping the plurality of second tracking detection blocks to the first image according to the homography matrix, when a coordinate corresponding to the mapping block exceeds a coordinate range of the first image, the mapping block exceeding the coordinate range of the first image is deleted.

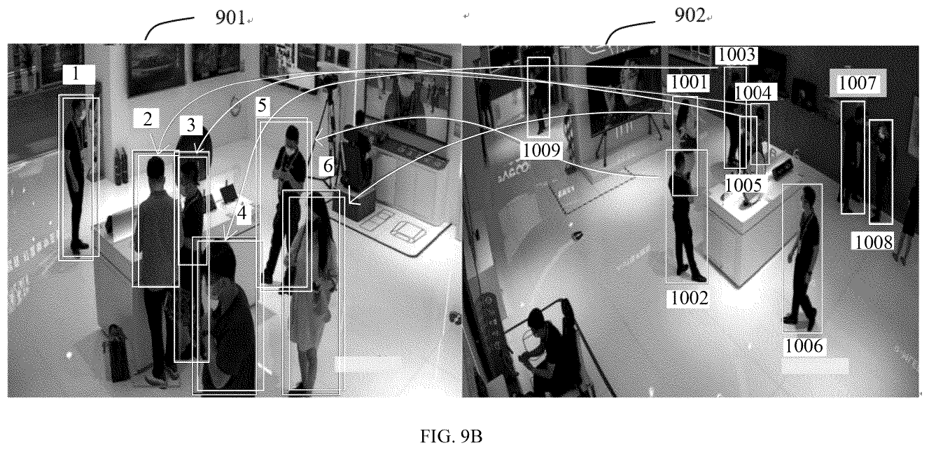

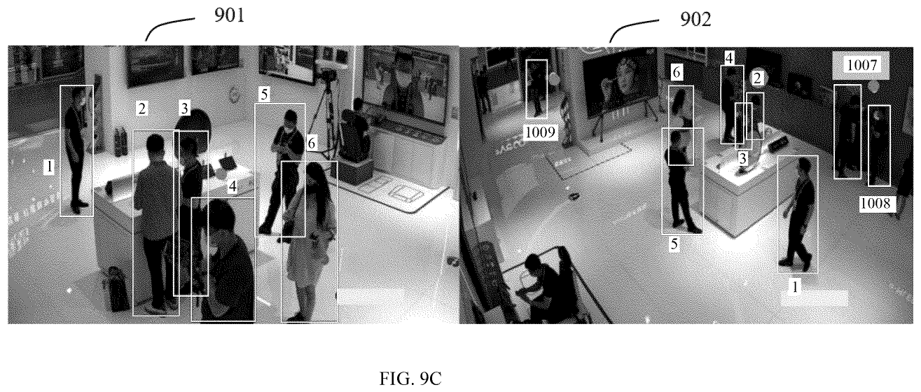

The present disclosure will be described below by taking a scenario of counting people distribution in a target region as an example. In a case where one image-collecting device cannot cover an entire target region, or in a case of poor collecting effect due to other reasons (such as sheltering), a first image-collecting device and a second image-collecting device may be deployed in the target region, a first image 901 in FIG. 9A is an image acquired by the first image-collecting device, a second image 902 is an image acquired by the second image-collecting device, as shown in FIG. 9A, target tracking is performed to the first image 901 to obtain a tracking identifier of each target object (from 1 to 6), and the target tracking is performed to the second image 902 to obtain a tracking identifier of each target object (from 1001 to 1009).

When people distribution in the target area is counted according to a target tracking result of the first image 901 and a target tracking result of the second image 902, it will be found that a same target object in the overlapping region of the first image 901 and the second image 902 has different tracking identifiers, which will result in an inaccurate statistical result, so the same target object in the overlapping region can be fused by using the present disclosure.

As shown in FIG. 9B below, the tracking result in the second image 902 is mapped to the first image 901 by using the homography matrix, and since the tracking detection blocks 1007, 1008, and 1009 in the second image 902 are mapped beyond an image range of the first image, the tracking detection blocks 1007, 1008, and 1009 in the second image 902 are filtered out.

After the tracking result in the second image 902 is mapped to the first image 901 by using the homography matrix, an IOU cost matrix H and a feature cost matrix F are calculated, and then a relation between the IOU cost matrix H and the feature cost matrix F is comprehensively considered to generate a cost matrix C, as shown in formula (6).

$$C = [ \begin{matrix}{IOU}_{11} & {IOU}_{i j} & {IOU}_{1 n} \\ {IOU}_{j i} & {IOU}_{i j} & {IOU}_{i j} \\ {IOU}_{m 1} & {IOU}_{i j} & {IOU}_{m n}\end{matrix} ] + γ [ \begin{matrix}{F}_{11} & {F}_{i j} & {F}_{1 n} \\ {F}_{j i} & {F}_{i j} & {F}_{i j} \\ {F}_{m 1} & {F}_{i j} & {F}_{m n}\end{matrix} ] \qquad Formula ( 6 )$$

In formula (6), y represents a weight of the appearance feature.

According to the cost matrix C, fusion of the first image 901 and the second image 902 is achieved by using the weighted bipartite graph matching algorithm, so that the same target object has a unique tracking identifier in a multi-camera vision, as shown in FIG. 9C, through fusion, it can be known that a target object with a tracking identifier of 1 in the first image 901 and a target object with a tracking identifier of 1006 in the second image 902 are a same target object, therefore, the tracking identifier of the target object in the second image 902 can be replaced with 1. Similarly, the tracking identifier 1001 in the second image 902 is replaced with 6, the tracking identifier 1002 in the second image 902 is replaced with 5, the tracking identifier 1003 in the second image 902 is replaced with 4, the tracking identifier 1004 in the second image 902 is replaced with 2, and the tracking identifier 1005 in the second image 902 is replaced with 3.

According to the above matching process, the target objects in the overlapping region may be fused, that is, the fusion includes unifying different tracking identifiers of the same target object in the overlapping region, so that the same target object has a globally unique tracking identifier in the target region. In this embodiment, in order to ensure the accuracy of fusion, a fusion result may be verified and wrong fusion results may be corrected.

Therefore, after replacing the second tracking identifier of the second tracking detection block corresponding to the mapping block with the first tracking identifier of the first tracking detection block, the method may further include:
for other image pairs excluding a synchronized first frame image pair, acquiring a fusing result of each of the other image pairs, where the each of the other image pairs includes the first image and the second image collected synchronously, and the fusing result indicates whether tracking identifiers of the same target object in the first image and the second image are consistent;
when the fusing result indicates that the tracking identifiers of the same target object are not consistent, and one of the tracking identifiers is presented for a first time, replacing the tracking identifier presented for the first time with the tracking identifier already presented before; and
when the fusing result indicates that the tracking identifiers of the same target object are not consistent, and each of the tracking identifiers is not presented for a first time, acquiring a matching similarity level of the target object between a tracking detection block and a predicted block in a previous frame image pair respectively, and using a tracking identifier of the target object in an image with a higher matching similarity level to replace a tracking identifier of the target object in other image.

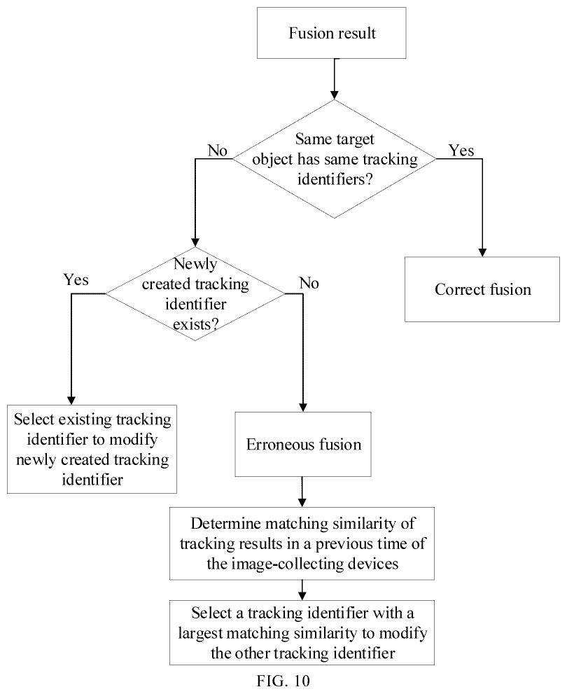

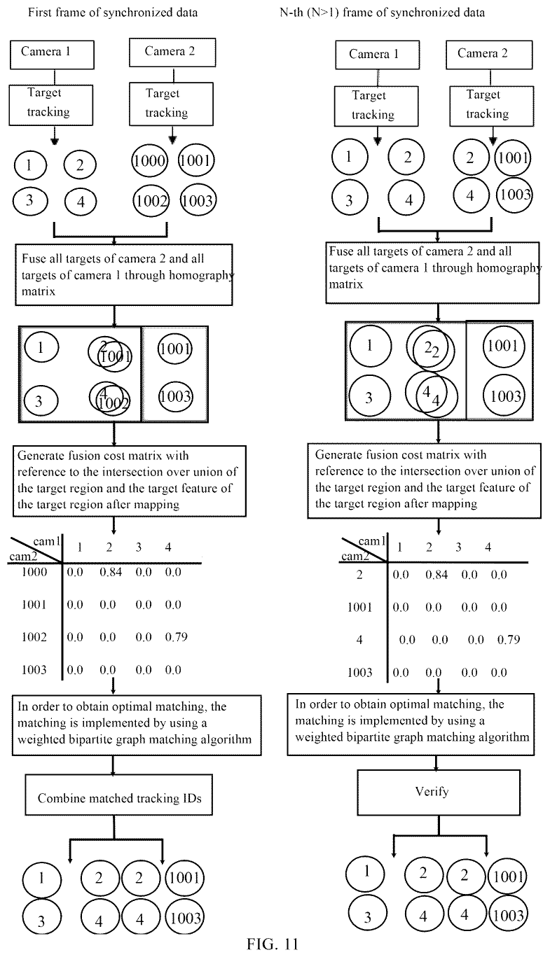

FIG. 10 is a schematic diagram of verifying a fusion result according to an embodiment of the present disclosure. As shown in FIG. 10, when the fusion result indicates that tracking identifiers of a same target object are consistent, it indicates a correct fusion.

When the fusion result indicates that tracking identifiers of a same target object are inconsistent, that is, the tracking identifier of the same target object in the first image are inconsistent with the tracking identifier in the second image, it is determined whether the tracker generating the tracking identifier appears for the first time (that is, newly initialized), and when the tracker generating the tracking identifier appears for the first time, the tracking identifier appearing for the first time is replaced with an existing tracking identifier. The existing tracking identifier may be understood as a tracking identifier that is correctly tracked for multiple times, considering the existing tracking identifier appears at least twice (the previous frame and the current frame), and it is indicated that probability that the target object is stably tracked is greater than probability that a new target object is appeared, and therefore, when two tracking identifiers appear for the same target object, and one of the tracking identifiers appears for the first time, the tracking identifier that appears for the first time is replaced with the existing tracking identifier.

For example, the target object a is sheltered in a view of the camera 1, but the target object a may be stably displayed in a view of the camera 2, in this case, a tracking identifier is already generated for the target object a in the image collected by the camera 2, and when the target object a appears in the camera 1, it may be determined, through fusion matching, that the target object a already exists, and therefore, the tracking identifier in the camera 2 is used as the globally unique tracking identifier of the target object a.

It can be seen from the above example that the problem of tracking identifier jump of the target object caused by sheltering in a single camera can be solved by verifying the fusion result.

When the fusion result indicates that the tracking identifiers of the same target object are inconsistent, and neither of the trackers that generate the tracking identifiers is newly created, that is, neither of the target object appears for the first time in the two image-collecting devices, it indicates that the fusion is incorrect. In this case, a last matching similarity level of the target object in the corresponding image-collecting devices may be determined respectively, and a tracking identifier with a larger matching similarity level in the last matching is used as the globally unique tracking identifier of the target object.

For example, the last matching similarity level of the target object M in the first image-collecting device is T1, and the last matching similarity level in the second image-collecting device is T2, and when T1 is greater than T2, the tracking identifier of the target object M in the second image-collecting device is replaced with the tracking identifier in the first image-collecting device.

When the fusion result indicates that the tracking identifiers of the same target object are inconsistent and the same target object appears not for the first time in the two image-collecting devices, it may be determined that the target object has a tracking error in a certain image-collecting device, for example, an exchange of the tracking identifiers occurs, and in this case, it may be determined, according to the tracking matching similarity level of the target object in the last single image-collecting device, that in which image-collecting device the target object has a jumping change, and in principle, it is considered that the image-collecting device with a low similarity level of the last single target matching has a jumping change, so that the tracking identifier with a low matching similarity level is corrected by using the tracking identifier with a high matching similarity level. In the above manner, when exchange of a tracking identifier of the target object occurs in tracking of the single image-collecting device, correction may be performed by using a tracking result in another image-collecting device, to improve tracking accuracy and ensure that a same target object has a same tracking identifier in two image-collecting devices.

In this embodiment, during target fusion, for tracking results without being matched and fused, original tracking identifiers are still maintained.

The present disclosure takes the camera 1 and the camera 2 with an overlapping view as an example to describe the process of using the present disclosure to achieve target tracking. FIG. 11 is a schematic diagram of a tracking time sequence according to an embodiment of the present disclosure, as shown in FIG. 11, target tracking is performed on the first frame synchronized data of the camera 1 and the camera 2 respectively.

This example describes a specific tracking process by using a target tracking process of the camera 1 as an example: acquiring a first image collected by the camera 1 in the first frame synchronized data, performing target detection on the first image to obtain a tracking detection block, extracting a target feature from the tracking detection block, creating a tracker by using a target region, and generating a unique tracking ID of a single target. As shown in FIG. 11, there are 4 targets in the first image, and unique tracking IDs of each target are 1, 2, 3, and 4 respectively.

A target tracking process of the camera 2 is similar to a target tracking process of the camera 1, and details are not repeated in this embodiment. As shown in FIG. 11, target tracking is performed on the camera 2, and there are 4 targets in the second image collected by the camera 2, and unique tracking IDs of the targets are respectively 1000, 1001, 1002, and 1003.

All targets in the camera 2 and all targets in the camera 1 are fused by using the homography matrix, that is, the tracking detection blocks corresponding to all targets in the camera 2 are mapped to the image coordinate system in which the camera 1 is located by using the homography matrix, and the cost matrix is generated based on the intersection over union of the mapped target region and the target feature of the target region, as shown in formula (1). In order to obtain optimal matching, the present embodiment implements matching by using a weighted bipartite graph matching algorithm, and combines matched tracking IDs.

As shown in FIG. 11, the target with a tracking ID of 2 in the camera 1 and the target with a tracking ID of 1000 in the camera 2 are the same target, therefore, the tracking ID of the target in the camera 2 may be replaced with 2 from 1000, that is, the tracking ID of the target in the camera 1 is used as the globally unique tracking ID. Similarly, the tracking ID of the target with a tracking ID of 1002 in the camera 2 is replaced with 4.

For an Nth (N>1) frame of synchronized data, similar to the first frame synchronized data, target tracking is performed on the Nth frame of synchronized data of the camera 1 and the camera 2 respectively, to obtain a tracking ID of each target in the respective camera. Theoretically, after the fusion processing on the first frame synchronized data, the same target located in the overlapping region has the same tracking ID in the two cameras. Therefore, in subsequent frames, when the fusion result indicates that tracking IDs of two matching tracking results are the same, it indicates that the matching is correct; otherwise, correction needs to be performed.

The correction process may include: when the fusion result indicates that the tracking IDs of the two matched tracking results are different, and the target appears for the first time in one of the cameras, using a tracking ID appears for most times as the unified tracking ID of the target. When the target does not appear for the first time in both cameras, a tracking ID with a high matching confidence in the single camera is selected as the unified tracking ID of the target.

Through verification, when the target object is sheltered in one of the cameras or erroneous jumping change of the single camera tracking ID occurs, correction can be performed in time to improve the accuracy of target tracking.

Based on homography transformation between images acquired by two cameras, coordinate mapping of the two camera images is completed in the present disclosure. The fusion of the target object in the overlapping region of the camera is completed through the target mapping relationship and the similarity level between the appearance feature, and the target tracking problem of the target object in the overlapping critical region is effectively solved. According to the present disclosure, the tracking target of the overlapping region is verified, so that the target object in the two cameras has a unique tracking identifier, and the tracking loss problem caused by single-view sheltering is effectively solved.

This embodiment may be applied to counting a distribution map of persons in an entire target region, for example, FIG. 9A, FIG. 9B, and FIG. 9C are field images in an exhibition region, and in order to count distribution and quantity of persons in the exhibition region, global person counting needs to be established, but a premise of obtaining correct distribution of persons is that there is a unique tracking identifier for persons located in an overlapping region in multiple cameras. Therefore, people in the overlapping region of the plurality of cameras can be fused by using the solution provided by the present disclosure, so that a same person has a unique tracking identifier globally.

This embodiment may be applied to a scenario in which an area of interest of a user exceeds a collecting view of a single camera, for example, when passenger flow in a large region is counted, a single camera cannot perform full-coverage shooting, multi-camera collaborative analysis and determination are required, and when multi-camera collaborative analysis is performed, the target fusion method of the present disclosure may provide effective technical support.

The tracking result in this embodiment may be displayed on a display screen of a mobile device, and the mobile device in this embodiment may be any product or component having a display function, such as an electronic paper, a mobile phone, a tablet computer, a television, a notebook computer, a digital photo frame, a navigator, or the like.

In this embodiment, the sheltering appearing in a single camera may be corrected, for example, it is known that a single camera will have serious sheltering, which will seriously affect the visual analysis result, for example, people whose tracking identifiers are 1004 and 1005 in the second image 902 in FIG. 9A have serious sheltering, in this case, in single camera tracking, person detection may fail, and person positioning and behavior analysis cannot be implemented. However, in multi-view camera tracking, a unique tracking identifier in multiple cameras can be ensured, and therefore, a single camera target may still be effectively analyzed and determined. That is, when the target object is sheltered in one camera, the view of the other camera may not be sheltered, so that the accuracy of person analysis can be ensured by using the tracking result in the camera without sheltering.

This embodiment may also be applied to an automatic vending rack, in which a camera is usually required to monitor changes of items, and in order to avoid sheltering of the item when a user takes the item, a plurality of cameras having overlapping collecting views may be provided, for example, cameras may be separately installed on two sides of a top end of the automatic vending rack, and the tracking target in two cameras having an overlapping region may be fused by using the solution provided by the present disclosure, to help analyze abnormal changes of the item in the automatic vending rack.

In an implementation, the tracking detection block may be transmitted as a part of the image frame to be displayed as a video stream to a display screen of the mobile device for display. This display mode is applicable to mobile devices with better CPU and GPU performance.

In another implementation, the video stream, the tracking detection block in each frame of image determined by the present disclosure, and the tracking identifier corresponding to the tracking detection block may be transmitted to the mobile device through different data channels, and after synchronous calibration is performed by the graphics card of the mobile device, a picture carrying the tracking detection block and the tracking identifier is displayed on the display screen.

For example, one data channel of the mobile device receives a normal video stream, and the other data channel receives a data packet carrying a tracking detection block of a coordinate position. The display card parses frame by frame, and combines the tracking detection block and the tracking identifier corresponding to each frame of image with the image according to the time information corresponding to the tracking detection block in the data packet, so that the picture carrying the tracking detection block is reproduced on the display screen.

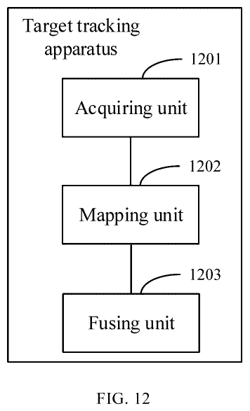

FIG. 12 is a schematic diagram of a target tracking apparatus according to an embodiment of the present disclosure.
an acquiring unit 1201, configured to acquire a first image and a second image synchronously collected by a first image-collecting device and a second image-collecting device, where the first image and the second image include an overlapping region; and acquire first tracking detection blocks and second tracking detection blocks, for target tracking, of the first image and the second image respectively;
a mapping unit 1202, configured to map the second tracking detection blocks to the first image according to a mapping relation between the first image-collecting device and the second image-collecting device, to obtain corresponding mapping blocks; and
a fusing unit 1203, configured to fuse target objects in the overlapping region according to intersection over union (IOU) and an appearance feature similarity level between the first tracking detection blocks and the mapping blocks.

In some embodiments, the fusing unit 1203 is specifically configured to:
determine a matched weight between each first tracking detection block and each mapping block according to intersection over union between each first tracking detection block and each mapping block and an appearance feature similarity level between each first tracking detection block and each mapping block;
match the first tracking detection blocks with the mapping blocks by using a weighted bipartite graph matching algorithm; and
when the first tracking detection block is matched with the mapping block, determine that a target object in the mapping block and a target object in the first tracking detection block are a same target object.

In some embodiments, the fusing unit 1203 is specifically configured to:
acquire a first tracking identifier assigned to each first tracking detection block when target tracking is performed to the first image, where the first tracking identifier is globally unique;
acquire a second tracking identifier assigned to each second tracking detection block when target tracking is performed to the second image, where the second tracking identifier is globally unique;
when determining that the target object in the mapping block and the target object in the first tracking detection block are the same target object, replace the second tracking identifier of a second tracking detection block corresponding to the mapping block with the first tracking identifier of the first tracking detection block.

In some embodiments, the apparatus further includes a verifying unit, configured to:
after replacing the second tracking identifier of a second tracking detection block corresponding to the mapping block with the first tracking identifier of the first tracking detection block, for other image pairs excluding a synchronized first frame image pair, acquire a fusing result of each of the other image pairs, where the each of the other image pairs includes the first image and the second image, and the fusing result indicates whether tracking identifiers of the same target object in the first image and the second image are consistent;
when the fusing result indicates that the tracking identifiers of the same target object are not consistent, and one of the tracking identifiers is presented for a first time, replace the tracking identifier presented for the first time with the tracking identifier already presented before; and
when the fusing result indicates that the tracking identifiers of the same target object are not consistent, and each of the tracking identifiers is not presented for a first time, acquire a matching similarity level of the target object between a tracking detection block and a predicted block in a previous frame image pair respectively, and use a tracking identifier of the target object in an image with a higher matching similarity level to replace a tracking identifier of the target object in other image.

In some embodiments, the acquiring unit 1201 is specifically configured to:
perform target detection to a first frame target image to obtain tracking detection blocks of target objects, creating a corresponding tracker and a corresponding feature library based on a tracking detection block of each target object, and assigning a tracking identifier to each target object, where the feature library is used to store an appearance feature of the target object, the target image includes the first image and the second image;
for other frame target images excluding the first frame target image, predict a predicted block of each of the target objects based on respective tracker, match based on intersection over union between each predicted block and each tracking detection block, and a similarity level between a first appearance feature of each target object in the feature library and a second appearance feature of each target object in the other frame target images;
for a tracking detection block matching with a corresponding predicted block, determine a tracking identifier of the predicted block as a tracking identifier of the tracking detection block in the other frame target images, and update a tracker using a position of the tracking detection block, and update the first appearance feature by using the second appearance feature; and
for a tracking detection block not matching with a corresponding predicted block, create a corresponding tracker according to the tracking detection block, assign a tracking identifier to the target object in the tracking detection block, and delete the tracker that generates the predicted block.

In some embodiments, the acquiring unit 1201 is further configured to:
predict predicted blocks of each of the target objects by using different target tracking algorithms;
acquire intersection over union between the predicted blocks predicted by using different target tracking algorithms and the tracking detection block respectively;
match each predicted block and each tracking detection block based on different intersection over union and the similarity level between the first appearance feature in the feature library and the second appearance feature of the tracking detection block.

In some embodiments, the acquiring unit 1201 is further configured to:
when target detection is performed to the target image, and when a specified target tracking algorithm in the different target tracking algorithms predicts that there is a predicted block of the target object, and no tracking detection block of the target object is detected, determine the predicted block of the target object predicted by the specified target tracking algorithm as the tracking detection block of the target object;
acquire intersection over union between the predicted blocks predicted by using different target tracking algorithms and each tracking detection block in the target image respectively;
match predicted blocks with tracking detection blocks based on different intersection over union and the similarity level between the first appearance feature in the feature library and the second appearance feature of each tracking detection block.

In some embodiments, the apparatus further includes a mapping-relation acquiring unit, configured to:
acquire a first calibration image and a second calibration image synchronously collected by the first image-collecting device and the second image-collecting device;
detect a first feature point of scale-invariant feature transform in the first calibration image and a second feature point of scale-invariant feature transform in the second calibration image;
match the first feature point in the first calibration image with the second feature point in the second calibration image to obtain a feature point pair; and
determine the mapping relation between the first image-collecting device and the second image-collecting device according to homogeneous coordinates of the first feature point in the feature point pair and homogeneous coordinates of the second feature point in the feature point pair.

In some embodiments, the mapping-relation acquiring unit is further configured to:
after matching the first feature point in the first calibration image with the second feature point in the second calibration image to obtain a feature point pair, acquire target first feature points included in feature point pairs in a specified region of the first calibration image;
acquire target second feature points, in the second calibration image, matched with all of the target first feature points in the specified region;
cluster all of the target second feature points in set regions, where a minimum distance between different set regions is greater than a size of the set regions, and the size of the set regions is equal to a size of the specified region;
acquire a target set region with a maximum number of the target second feature points; and
update feature point pairs including all of the target second feature points in the target set region as feature point pairs in the first calibration image and the second calibration image.

In some embodiments, the acquiring unit 1201 is specifically configured to:
acquire a first data stream collected by the first image-collecting device by using a first pull stream thread, storing the first data stream in a first queue, acquire a second data stream collected by the second image-collecting device by using a second pull stream thread, and storing the second data stream in a second queue;
decode the first data stream in the first queue by using a first decoding thread to obtain the first image, store the first image in a third queue, decode the second data stream in the second queue by using a second decoding thread to obtain the second image, and store the second image in the third queue;
when the second image or the first image collected synchronously is not received beyond a set duration starting from receiving the first image or the second image, perform target tracking on the received first image or the received second image, and empty the third queue; and
when the second image or the first image collected synchronously is received beyond the set duration starting from receiving the first image or the second image, determine the first image and the second image as images synchronously collected by the first image-collecting device and the second image-collecting device, and empty the third queue.

In the present disclosure, the terms “first” and “second” are used for descriptive purposes only, and cannot be understood as indicating or implying relative importance. The term “plurality” refers to two or more unless expressly defined otherwise.

Other embodiments of the present disclosure will be readily apparent to those skilled in the art upon consideration of the specification and practice of the disclosure disclosed herein. The present disclosure is intended to cover any variations, uses or adaptations of the present disclosure that follow the general principles of the present disclosure and include common knowledge or conventional technical means in the art not disclosed herein. The specification and examples are to be regarded as exemplary only, and the true scope and spirit of the present disclosure are indicated by the following claims.

It should be understood that the present disclosure is not limited to the precise structure already described above and shown in the drawings, and that various modifications and changes may be made without departing from the scope thereof. The scope of the present disclosure is limited only by the appended claims.

1. A method, comprising:
acquiring a first image and a second image synchronously collected by a first image-collecting device and a second image-collecting device respectively, wherein the first image and the second image comprise an overlapping region;
acquiring first tracking detection blocks and second tracking detection blocks of the first image and the second image respectively;
mapping the second tracking detection blocks to the first image according to a mapping relation between the first image-collecting device and the second image-collecting device, to obtain mapping blocks; and
fusing target objects in the overlapping region according to intersection over union (IOU) and an appearance feature similarity level between the first tracking detection blocks and the mapping blocks.

2. The method according to claim 1, wherein fusing the target objects comprises:
determining a matched weight between each of the first tracking detection blocks and each of the mapping blocks according to intersection over union between the each first tracking detection block and the each mapping block and an appearance feature similarity level between the each first tracking detection block and the each mapping block;
matching the first tracking detection blocks with the mapping blocks by using a weighted bipartite graph matching algorithm; and
in response to the each first tracking detection block being matched with the each mapping block, determining that a target object in the each mapping block and a target object in the each first tracking detection block are a same target object.

3. The method according to claim 1, further comprising:
acquiring a first tracking identifier assigned to the each first tracking detection block when target tracking is performed to the first image, wherein the first tracking identifier is globally unique;
acquiring a second tracking identifier assigned to the each second tracking detection block when target tracking is performed to the second image, wherein the second tracking identifier is globally unique; and
in response to the target object in the each mapping block and the target object in the each first tracking detection block being the same target object, replacing the second tracking identifier with the first tracking identifier.

4. The method according to claim 3, wherein the method further comprises:
for another image pair excluding a synchronized first frame image pair, acquiring a fusing result of the another image pair, wherein the another image pair comprises a next first image and a next second image, and the fusing result indicates whether tracking identifiers of a same target object in the next first image and the next second image are consistent;
in response the fusing result indicating that the tracking identifiers of the same target object in the next first image and the next second image are not consistent, and one of the tracking identifiers is presented for a first time, replacing the one of the tracking identifiers presented for the first time with the other of the tracking identifiers already presented before; and
in response the fusing result indicating that the tracking identifiers of the same target object in the next first image and the next second image are not consistent, and each of the tracking identifiers is not presented for a first time, respectively acquiring matching similarity levels of the target object between a tracking detection block and a predicted block in a previous frame image pair, and using a tracking identifier of the target object in an image with a higher matching similarity level to replace a tracking identifier of the target object in the next first image and a tracking identifier of the target object in the next second image.

5. The method according to claim 1, wherein acquiring the first tracking detection blocks and the second tracking detection blocks comprises:
performing target detection to a first frame target image to obtain tracking detection blocks of target objects, creating a corresponding tracker and a corresponding feature library based on a tracking detection block of each of the target objects, and assigning a tracking identifier to the each target object, wherein the feature library stores an appearance feature of the target object, the target image comprises the first image and the second image;
for another frame target image excluding the first frame target image, predicting a predicted block of each of the target objects based on respective trackers, matching based on intersection over union between each predicted block and each tracking detection block, and a similarity level between a first appearance feature of each target object in the feature library and a second appearance feature of each target object in the another frame target image;
for the tracking detection block matched with the predicted block, determining a tracking identifier of the predicted block as a tracking identifier of the tracking detection block in the another frame target image, and updating the tracker with a position of the tracking detection block, and updating the first appearance feature with the second appearance feature; and
for the tracking detection block not matched with the predicted block, creating a corresponding tracker according to the tracking detection block, assigning a tracking identifier to the target object in the tracking detection block, and deleting the tracker that generates the predicted block.

6. The method according to claim 5, wherein matching based on the intersection over union between the each predicted block and the each tracking detection block, and the similarity level between the first appearance feature of the each target object in the feature library and the second appearance feature of the each target object in the another frame target image comprises:
predicting a predicted block of each of the target objects by using different target tracking algorithms;
acquiring intersection over union between the predicted blocks predicted by using different target tracking algorithms and the tracking detection block respectively; and
matching each predicted block with the tracking detection block based on different intersection over union and the similarity level between the first appearance feature in the feature library and the second appearance feature of the tracking detection block.

7. The method according to claim 6, further comprising:
when target detection is performed on the target image, and when a specified target tracking algorithm in the different target tracking algorithms predicts that there is a predicted block of the target object, and no tracking detection block of the target object is detected, determining the predicted block of the target object predicted by the specified target tracking algorithm as the tracking detection block of the target object;
acquiring intersection over union between the predicted blocks predicted by using different target tracking algorithms and each tracking detection block in the target image respectively;
matching predicted blocks with tracking detection blocks based on different intersection over union and the similarity level between the first appearance feature in the feature library and the second appearance feature of each tracking detection block.

8. The method according to claim 1, further comprising:
acquiring a first calibration image and a second calibration image synchronously collected by the first image-collecting device and the second image-collecting device;
detecting first feature points of scale-invariant feature transform in the first calibration image and second feature points of scale-invariant feature transform in the second calibration image;
matching the first feature points in the first calibration image with the second feature points in the second calibration image to obtain feature point pairs; and
determining the mapping relation between the first image-collecting device and the second image-collecting device according to homogeneous coordinates of the first feature point in the feature point pair and homogeneous coordinates of the second feature point in the feature point pairs.

9. The method according to claim 8, wherein the method further comprises:
acquiring target first feature points comprised in the feature point pairs in a specified region of the first calibration image;
acquiring target second feature points, in the second calibration image, matched with all of the target first feature points in the specified region;
clustering all of the target second feature points in set regions;
determining a set region with a maximum number of the target second feature points as a target set region; and
updating feature point pairs comprising all of the target second feature points in the target set region as feature point pairs in the first calibration image and the second calibration image.

10. The method according to claim 1, wherein acquiring the first image and the second image synchronously collected by the first image-collecting device and the second image-collecting device comprises:
acquiring a first data stream collected by the first image-collecting device by using a first pull camera stream thread, storing the first data stream in a first queue, acquiring a second data stream collected by the second image-collecting device by using a second pull camera stream thread, and storing the second data stream in a second queue;
decoding the first data stream in the first queue by using a first decoding thread to obtain the first image, storing the first image in a third queue, decoding the second data stream in the second queue by using a second decoding thread to obtain the second image, and storing the second image in the third queue;
when the second image or the first image collected synchronously is not received beyond a set duration starting from receiving the first image or the second image, performing target tracking on the received first image or the received second image, and emptying the third queue; and
when the second image or the first image collected synchronously is received within the set duration starting from receiving the first image or the second image, determining the first image and the second image as images synchronously collected by the first image-collecting device and the second image-collecting device, and emptying the third queue.

11. The method according to claim 1, further comprising:
mapping the first tracking detection blocks to the second image according to the mapping relation between the first image-collecting device and the second image-collecting device, to obtain the mapping blocks; and
fusing the target objects in the overlapping region according to intersection over union (IOU) and an appearance feature similarity level between the second tracking detection blocks and the mapping blocks.

12. (canceled)
